(19) United States
(12) Patent Application Publication
(10) Pub. No.: US 2014/0326730 A1
(43) Pub. Date: Nov. 6, 2014

(54) WASTE-DISPOSAL DEVICE

(71) Applicant: Michel Morand, Montreal (CA)

(72) Inventor: Michel Morand, Montreal (CA)

(73) Assignee: INTERNATIONAL REFILLS COMPANY LIMITED, Barbados (BB)

(21) Appl. No.: 14/343,137

(22) PCT Filed: Aug. 31, 2012
(86) PCT No.: PCT/IB12/01689

§ 371 Date: Jun. 11, 2014

(30) Foreign Application Priority Data
Sep. 6, 2011 (CA) 2751704

(51) Int. Cl. B65F 1/14; B65F 1/06

(52) U.S. Cl. CPC B65F 1/1615; B65F 1/06; B65F 2001/1676
USPC 220/495.06

(57) ABSTRACT

A waste-disposal device comprises a structure having a top opening supporting an opened bag. A closed end of the bag is below the opening. A lid assembly comprises a pivoting lid mounted to the structure. A jaw mechanism comprises a pair of jaws. One jaw is connected to the structure below the opening, moving between a clamped position, in which the jaws close off a portion of the bag, and an opened position, in which the jaws are separated, allowing waste to reach the closed end. An actuation link connected to the structure in guide and follower engagement with the jaws causes movement of the jaws between the clamped and opened positions. The link contacts the lid to move concurrently with it. A biasing element biases the link to raise the lid. A retaining mechanism holds the lid closed against a biasing pressure of the actuation link when the lid is pushed downwardly to close access to the opening. A method for disposal of a waste object in a waste-disposal device is also provided.

### FIELD OF THE APPLICATION

The present application relates to a waste-disposal device and, more particularly but not exclusively, to a waste-disposal device for the disposal of odorous waste, such as diapers, litter, foodstuff, etc.

### BACKGROUND OF THE ART

Waste-disposal devices having odor-concealing systems are well known. Such waste-disposal devices typically comprise a bag that is closed off by given mechanisms, to conceal the odors within the bag. U.S. Pat. No. 6,817,164 (Mauffette et al.) and U.S. Pat. No. 7,406,814 (Morand) propose such odor-concealing systems. However, it is desired to provide a waste-disposal device that is simple in construction, and that may have the option of being actuated automatically to ingest waste.

### SUMMARY OF THE APPLICATION

It is therefore an aim of the present disclosure to provide a novel waste-disposal device.

Therefore, in accordance with the present disclosure, there is provided a waste-disposal device comprising: a structure having an opening at a top end and supporting a bag opened at the opening of the structure, with a closed end of the bag being below the opening; a lid assembly mounted to the structure and having a lid pivoting to close/open access to the opening; and a jaw mechanism comprising a single pair of jaws with at least one of the jaws movingly connected to the structure below the opening to move between a clamped position in which the jaws concurrently close off a portion of the bag passing therebetween, and an opened position in which the jaws are separated to allow waste to reach the closed end of the bag under the single pair of jaws; an actuation link movingly connected to the structure and in a guide and follower engagement with the single pair of jaws to cause a movement of at least one of the jaws between the clamped position and the opened position as a result of movement of the actuation link relative to the structure, the actuation link contacting the lid for moving concurrently with the lid; at least one biasing element biasing the actuation link upwardly to raise the lid; and a retaining mechanism to hold the lid closed against a biasing pressure of the actuation link when the lid is pushed downwardly to close the access to the opening.

Further in accordance with the present disclosure, the jaws are U-shaped jaws with each said jaw being oriented upright in the clamped position.

Still further in accordance with the present disclosure, the actuation link translates in a generally vertical direction relative to the structure, the actuation link having an edge slidingly contacting at least one arm of the lid to (1) displace the lid to open an access to the opening as biased by the at least one biasing element, and to (2) be pushed downward when the lid is manually pushed downwardly to close the access to the access to the opening.

Still further in accordance with the present disclosure, both of the jaws are pivotally connected to the structure, and wherein the guide and follower engagement between the jaws and the actuation link comprises a follower finger projecting from each said jaw into guide slots in the actuation link for the jaws to move between the clamped position and the opened position as a function of a translation of the actuation link in the generally vertical direction.

Still further in accordance with the present disclosure, the guide slots each have straight portion and a bent portion, the jaws moving from the clamped position to the opened position and back to the clamped position when each of the follower fingers moves sequentially from the straight portion, to the bent portion, to return to the straight portion.

Still further in accordance with the present disclosure, a one-way channel unit is in the straight portion, with the bent portion joined in parallel relation with the straight portion, the jaws moving from the clamped position, to the opened position and back to the clamped position when the follower fingers each move into a corresponding one of the bent portion as a function of a closing of the lid, the jaws remaining in the clamped position when the follower fingers move in the straight portion and over the one-way channel unit when the lid is raised by the biasing force, the follower fingers being directed to the bent portion by the one-way channel unit.

Still further in accordance with the present disclosure, the one-way channel unit is a ramp in the straight portion with the follower fingers passing over the ramp when the lid is being opened, the ramp directing the follower finger to the bent portion when the lid is being closed, to move the jaws to the opened position.

Still further in accordance with the present disclosure, a translational joint is defined at respective pivots of the jaws with the structure for movement of the jaws along an axis of the pivots to allow the follower fingers to pass over the ramp, and further comprising biasing means to bias the jaws for the follower fingers to contact the ramp.

Still further in accordance with the present disclosure, meshing is on a periphery of the jaws, whereby the jaws are intermeshed for concurrent rotation between the clamped position and the opened position.

Still further in accordance with the present disclosure, at least one biasing element biases the jaws toward one another.

Still further in accordance with the present disclosure, the jaws have a wavy edge at a region of contact therebetween.

Still further in accordance with the present disclosure, the structure is a container defining an inner cavity, with the jaw mechanism being at least partially within the inner cavity of the container.

Still further in accordance with the present disclosure, the container comprises a top portion and a base portion, the top portion being pivotally connected to the base portion for access to the inner cavity of the container.

Still further in accordance with the present disclosure, the lid assembly comprises an annular base secured to a structure, the annular base having a central opening providing access to the opening of the structure.

Still further in accordance with the present disclosure, the retaining mechanism is a latch unit on the annular base cooperating with a catch on the lid.

Further in accordance with the present disclosure, there is provided a method for the disposal of a waste object in a waste-disposal device comprising a structure with an opening at a top end closed by a lid, a bag opened at the opening and having a closed end below the opening, jaws closing off a portion of the bag passing therebetween, the method comprising: lifting the lid by a biasing force when the lid is released from a latched closed position; receiving a waste object in the bag on top of the jaws; separating the jaws for the waste object to fall under the jaws in the closed end of the bag as a result of a manual pressure applied on the lid to close the lid; bringing the jaws against one another with the bag therebetween and the waste object captive in the closed end of the bag below the jaws a result of a manual pressure applied on the lid to close the lid; and retaining the lid in the closed position against the biasing forces.

Still further in accordance with the present disclosure, lifting the lid comprises keeping the jaws against one another continuously while the biasing force is applied to the lid.

Still further in accordance with the present disclosure, keeping the jaws against one another comprises shifting the jaws laterally in engagement a one-way channel unit to avoid being opened.

Still further in accordance with the present disclosure, separating the jaws and subsequently bringing the jaws against one another occur once the lid is in close proximity to a closed position.

### BRIEF DESCRIPTION OF THE DRAWINGS

FIG. 1 is a perspective view, partly sectioned, of a waste-disposal device constructed in accordance with an embodiment of the present disclosure;

FIG. 2 is an exploded view of a jaw mechanism and lid assembly of the waste-disposal device of FIG. 1;

FIGS. 3-6 are perspective views of the jaw mechanism and lid assembly of FIG. 2, in an opening and closing sequence;

FIG. 7 is a perspective view of an actuation link of the jaw mechanism, and the lid assembly of the waste-disposal device of FIG. 1;

FIG. 8 is a perspective view of a jaw-opening interface of the actuation link of the waste-disposal device of FIG. 7;

FIG. 9 is a schematic view of the jaw-opening interface of FIG. 8, illustrating downward movement thereof with respect to follower fingers; and

FIG. 10 is a schematic view of the jaw-opening interface of FIG. 8, illustrating upward movement thereof with respect to the follower fingers.

### DESCRIPTION OF THE PREFERRED EMBODIMENTS

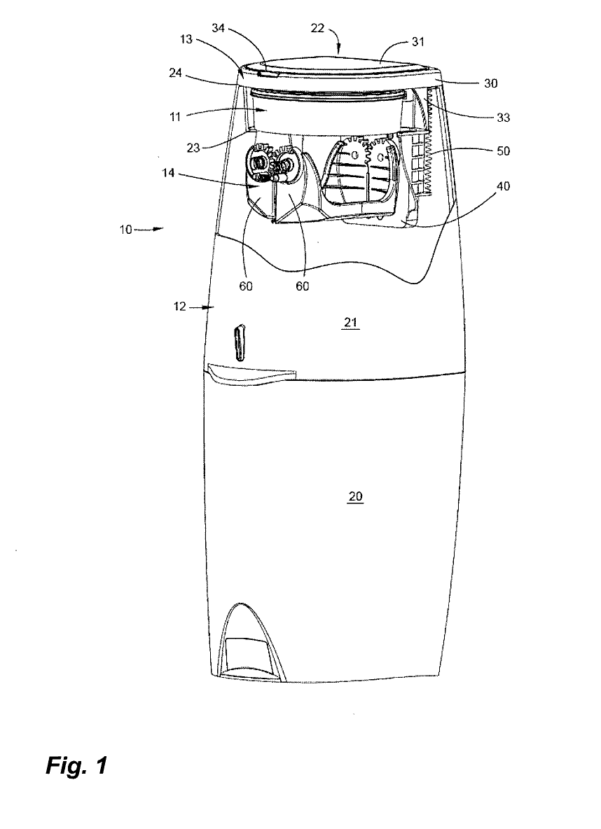

Referring to the drawings and more particularly to FIG. 1, a waste-disposal device (hereinafter “device”) is generally shown at 10. The device 10 is of the type using a cassette 11 dispensing a tubular bag, in the manner described in U.S. Pat. No. 6,974,029, by Morand et al., and in the manner described in Canadian Patent Application Publication No. 2,726,926, by Morand et al., amongst other possibilities. Any other suitable type of bag dispenser may be used as well with the device 10. Moreover, the device 10 may be used with individual bags as well (as opposed to being part of a dispensing cassette).

The device 10 has a structure such as a container 12, a lid assembly 13 and a jaw mechanism 14.

The container 12 forms the structure of the device 10, and accommodates and conceals the tubular bag containing waste. The container 12 is not limited to the shape illustrated in the figures. Any suitable geometry is considered as well. Moreover, the device 10 may alternatively be a structure supporting the lid assembly 13 and jaw mechanism 14, without a casing such as the container. For example, a wire meshing structure could be used. For simplicity purposes, reference will be made hereinafter to the container 12.

The lid assembly 13 is manually operated to open and close a top opening of the container 12, through which the waste is thrown into the bag of the device 10.

The jaw mechanism 14 responds to a closing of the lid assembly 13 to move a pair of jaws that close off the bag to seal odors therein. The jaws may be arranged to have the bag closed when the lid of the lid assembly 13 is opened, as described hereinafter.

Referring to FIG. 1, the container 12 may have a base portion 20 and a top portion 21, that are separable to provide access to an interior of the container 12 for emptying the device 10. The container 12 may also be a single tubular unit. An opening 22 is at a top of the container 12. The opening 22 provides access to an interior of the container 12, for the disposal of waste in the bag.

A shoulder 23 inside the container 12 defines a seat for the cassette 11, in such a way that the tubular bag projects into an inner cavity of the container 12. According to an embodiment, the shoulder 23 has a specific geometry, requiring the cassette 11 to be inserted in the proper orientation. Any other suitable configuration may be used to support the cassette 11, or to support a bag on its own. For instance, the cassette 11 may have its own shoulder to be self-supported on a periphery of the opening 22.

An upper annular rim 24 bounds the opening 22, and is the interface between the lid assembly 13 and the container 12. Support arms (not shown to simplify the figures) may be provided to project from a top of the container 12 (e.g., from a bottom of the seat 23 or rim 24) into the inner cavity of the container 12, and support components of the jaw mechanism 14, as is described hereinafter.

Complementary hinge portions (not shown) may be positioned on a rear side of the base portion 20 and top portion 21 of the container 12, so as to allow pivoting motion of the top portion 21 with respect to the base portion 20 for accessing an interior of the container 12.

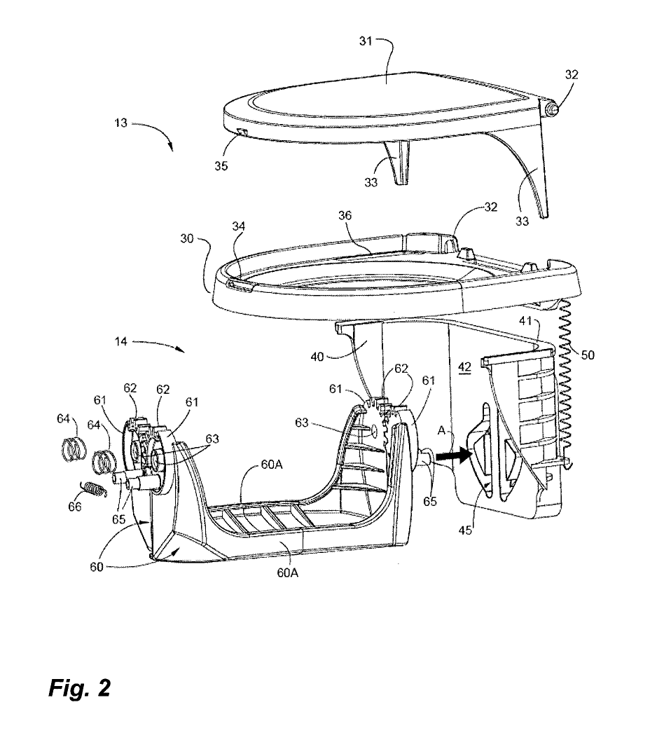

Still referring to FIGS. 1 and 2, the lid assembly 13 has an annular base 30. The geometry of the annular base 30 is complementary to that of the upper annular rim 24. Accordingly, the annular base 30 of the lid assembly 13 is seated on the annular rim 24 of the container 12. Other interconnection arrangements are considered as well, such as a press-fit, quick-connect system, threading engagement, or the like.

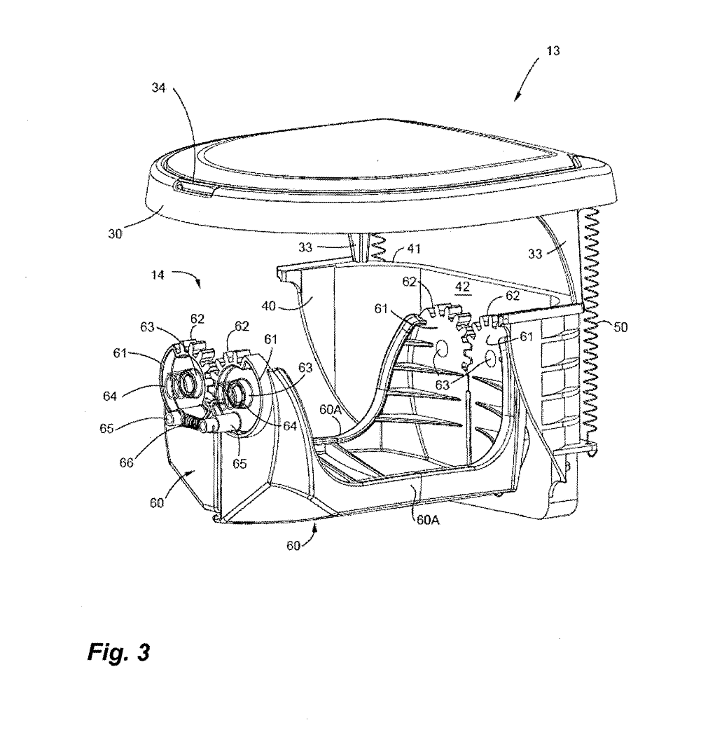

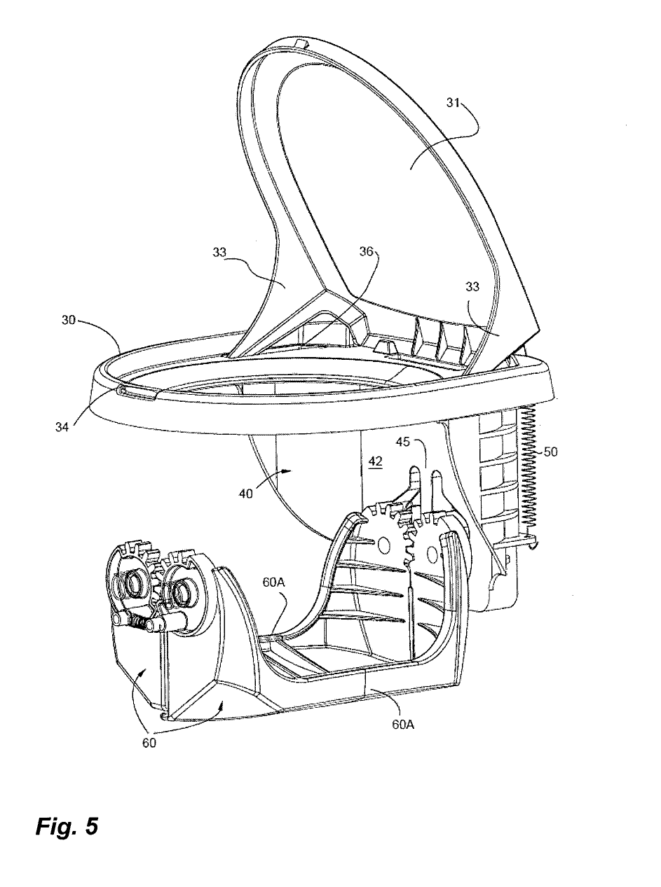

A lid 31 is pivotally connected to the annular base 30 by hinge 32 (FIG. 2). Therefore, the lid 31 may pivot between an opened position, as shown in FIG. 5, and a closed position, as shown in FIG. 3. In the closed position, the lid 31 blocks the opening 22. In the opened position, the opening 22 is exposed, whereby a user may throw waste into the bag in the device 10.

Referring to FIGS. 1 and 2, a pair of arms 33 project downwardly from the lid 31, and are integral therewith. The device 10 may have a single one of the arms 33, or more than two. The arms 33 project into the inner cavity of the container 12 when the lid is closed (e.g., FIG. 1).

A retaining mechanism features a detent 34 (i.e., as part of a latch) that is biased to hold the lid 31 captive when engaged to the base 30, in the closed position illustrated in FIG. 3. A manual pressure may be applied to the detent 34 to release the lid 31 from the captive engagement with the base 30. The detent 34 may cooperate with a lip of the lid 31, or with catch 35 (FIG. 2). It is observed from FIG. 2 that slots 36 are defined in the base 30, for the arms 33 to be threaded therethrough into the inner cavity of the container 12.

Referring concurrently to FIGS. 1-6, the jaw mechanism 14 of the device 10 comprises an actuation link 40. The actuation link 40 is mounted to the container 12 so as to translate along a generally vertical axis. The container 12 and the actuation link 40 therefore have structural components enabling the translation or sliding of the actuation link 40 relative to the container 12. The actuation link 40 has a generally smooth upper edge 41, as well as a generally flat inward surface 42, respectively cooperating with the lid assembly 13 and jaws, as described hereinafter.

Referring to FIGS. 2 and 7-10, the actuation link 40 of the device 10 has a jaw-opening interface 45. The jaw-opening interface 45 is a network of channels defined in the inward surface 42 of the actuation link 40. The jaw-opening interface 45 is operatively connected to jaws, as described below, to convert the translational movement of the actuation link 40 to clamping motion of jaws (i.e., reciprocating opening and closing motion of the jaws). The jaw-opening interface 45 may have straight slot portions 46 and guiding slot portions 47 (i.e., cam portions).

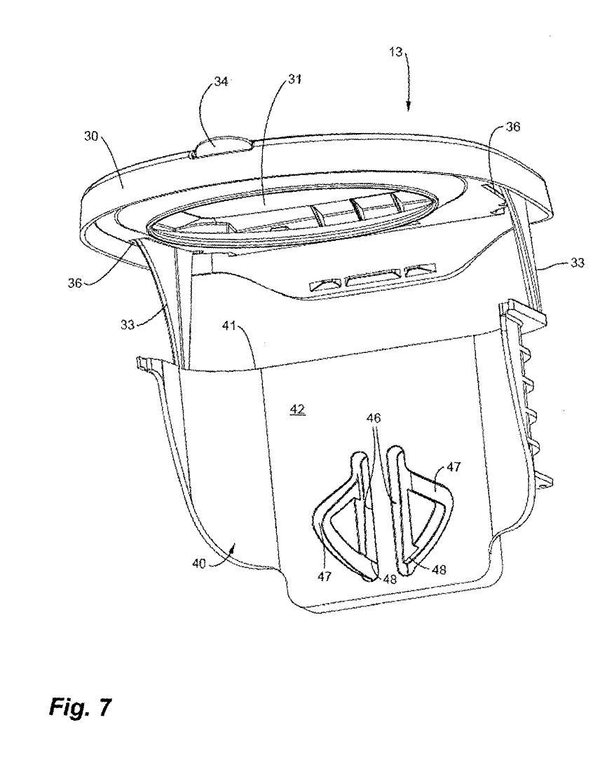

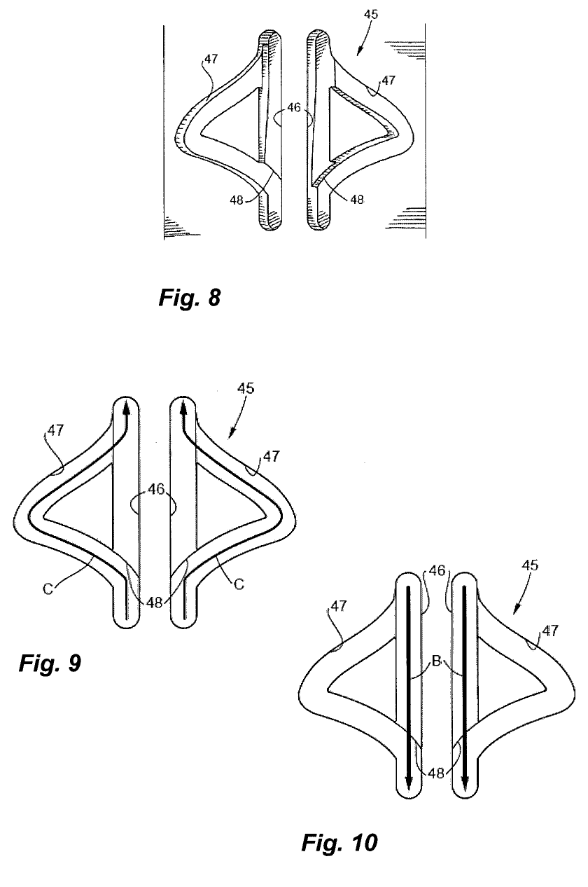

According to one embodiment, as best shown in FIGS. 7 and 8, by-pass mechanisms may be provided in the jaw-opening interface 45. The by-pass mechanisms each comprise a one-way channel unit such as a ramp 48 positioned in the straight slot portion 46. Other one-way channel units may be used for the by-pass mechanisms as alternatives to the ramps 48, such as pivoting mechanisms or the like. An interaction of the jaw-opening interface 45 with jaws will be described hereinafter.

Biasing elements 50, such as helical springs, leaf springs, etc., are connected to the actuation link 40 at one end, and to the container 12 at the other end. The biasing elements 50 bias the actuation link 40 toward the lid 31, and therefore the upper edge 41 of the actuation link 40 forcefully comes into contact with the arms 33 of the lid assembly 13. Throughout movements of the actuation link 40, as illustrated in FIGS. 1-6, the arms 33 will be in contact with the actuation link 40 by the action of the biasing elements 50.

Accordingly, an upward movement of the actuation link 40 results in the opening of the lid 31 by the pushing action of the upper edge 41 on the arms 33 integral with the lid 31. Similarly, a downward movement of the actuation link 40 causes the movement of the lid 31 toward the closed position, by the arms 33 following the actuation link 40.

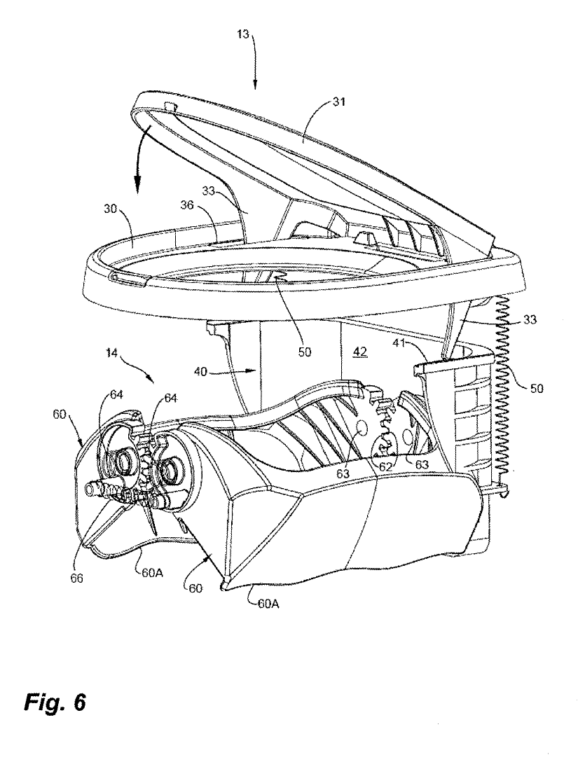

The jaw mechanism 14 further comprises a pair of jaws 60. Each jaw 60 is generally U-shaped, and has a generally horizontal bar 60A, with the bars 60A of the jaws 60 being normally one against the other in a clamping position, as shown in FIGS. 1-5, to press shut the bag passing therebetween. The bars 60A may be separated from one another in an opened position, as shown in FIG. 6, for the bag to swallow waste, i.e., allow the waste to fall to the bottom of the bag, below the jaws 60. As shown in FIG. 6, the bars 60A may have an edge with wavy pattern 60B to increase a contact surface between the bars 60A and the bag, and to avoid having straight edges in case of manual contact with the bars 60. Other patterns, including a straight pattern, may be used as well.

The jaws 60 each have a pair of pivot heads 61. The pivot heads 61 are generally circular in shape, and may have teeth 62 on their periphery. The teeth 62 are sized to mesh with the teeth 62 of the pivot head 61 of the other jaw 60. The intermeshed teeth 62 ensure the concurrent motion of the jaws 60, between and to the positions illustrated in FIGS. 1-6.

On both sides of the jaws 60, pivot holes 63 are provided so as to cooperate with pivots of the container 12, which pivots project laterally into the pivot holes 63, so that the jaws 60 rotate about the pivot holes 63. Alternatively, the pivot holes could be part of the container 12, with corresponding pivots in the jaws. Accordingly, the jaws 60 are in pivoting engagement with the container 12, to effect the closing/opening motion represented by the positions of FIGS. 1-6. Moreover, the pivot holes 63 may be in a telescopic relation with their respective supports of the container 12, to allow some lateral play. Alternatives to the telescopic relation are also considered, such as cylindrical joints, etc.

Biasing elements, such as helical springs, leaf springs, etc., are shown at 64, and are mounted around the pivots in the vicinity of the pivot holes 63, on a single side of the jaws 60. The biasing elements 64 bias the jaws 60 toward direction A, in the lateral play allowed by the telescopic relation between the pivot holes 63 and their pivots in the container 12.

Fingers 65 also project laterally relative from the side of the jaws 60 away from the actuation link 40. The fingers 65 may be integral with the jaws 60, and are eccentrically located on the jaws 60, namely are off-center with respect to the pivot holes 63. The fingers 65 may be interconnected by a biasing element 66 (e.g., helical spring, leaf spring, etc.), so as to be biased toward one another, and thus to the clamped position of FIGS. 3-5. Accordingly, when the jaws 60 are moved to the opened position (FIG. 6), the biasing element 66 opposes a force to bring the jaws 60 back to the clamping position.

Fingers 67 on the other side of the jaws 60 are used as follower fingers (a.k.a., cam followers) and are therefore in operative engagement with the jaw-opening interface 45 of the actuation unit 40. The follower fingers 67 are received inside the straight slot portions 46 and guiding slot portions 47 of the actuation link 40. The movement of the jaws 60 is a result of the follower fingers 67 moving inside the slot portions 46 and 47.

The jaws 60 may have configurations other than those described above. For instance, the jaws 60 may be mounted to the container 12 so as to translate, as opposed to rotate. In such a case, the jaws 60 would be supported by rails, and biased toward one another. Moreover, pivots and pivot holes, may be integral with the jaws 60, or separated therefrom. It is also considered to have a single one of the jaws 60 move to perform the clamping motion with the other jaw 60 being fixed. Although the embodiments described herein refer to a pair of jaws 60, a single movable jaw 60 may abut against a structural surface of the container or against any other part of the device 10. However, this structural surface is referred to as a jaw throughout the description and in the claims.

Now that the various components of the device 10 have been described, an operation thereof is set forth with reference to the figures.

The device 10 is normally in the position of FIGS. 1 and 3, with the jaws 60 in the clamped position, and the lid 31 in the closed position, as held by the detent 34. It is observed that the actuation link 40 is in abutment against the arms 33, as biased by the biasing elements 50. Therefore, the actuation link 40 exerts an upward pressure on the lid 31, via the arms 33. Moreover, in the state of FIGS. 1 and 3, the follower fingers 67 (FIG. 2) are in a top end of the straight slot portions 46.

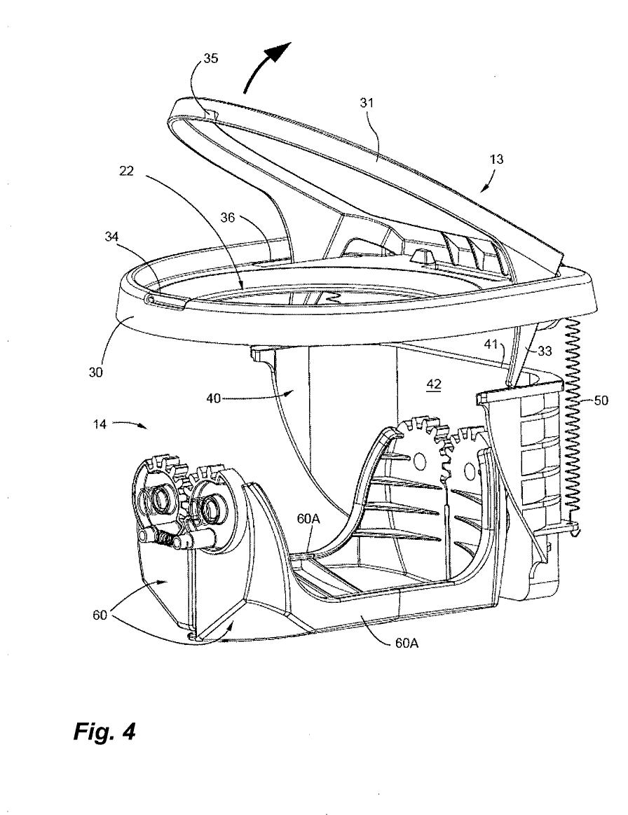

Referring to FIG. 4, the lid 31 is opened as a result of a manual pressure on the detent 34. As the detent 34 no longer holds the lid 31 captive to the base 30, the lid 31 pivots toward the opened position of FIG. 5.

During the opening action of the lid 31, the actuation link 40 moves upward with respect to the follower fingers 67, whereby the follower fingers 67 move along the straight slot portions 46 along direction B (FIG. 10). The follower fingers 67 slide above the ramps 48, resulting in the lateral movement of the jaws 60 against the biasing action of the biasing elements 64. This lateral movement along A is allowed by the lateral play resulting from the telescopic arrangement of the pivot holes 63. As an alternative, the actuation link 40 may be resilient enough to temporarily deform. As yet another alternative, biased flaps may be used to alleviate the need for a lateral play. Numerous alternatives exist. Therefore, the follower fingers 67 reach a bottom of the straight slot portions 46, and this corresponds to the lid 31 reaching the opened position of FIG. 5, with the jaws 60 remain clamped throughout the downward motion of the actuation link 40.

The user may thus dump waste in the device 10, and the waste will be held up in the device 10 above the jaws 60, as the jaws 60 are in their clamped position. The user may at that point initiate the closing of the device 10, by manually pushing the lid 31 downwardly to return same to the closed position of FIG. 3, against the action of the biasing elements 50 (selected in terms of biasing force to allow manual closing).

As a result of the lid 31 moving toward the closed position of FIG. 3, the actuation link 40 moves downwardly with respect to the follower fingers 67. The ends of the ramps 58 will prevent the follower fingers 67 from moving along the straight slot portions 46. Rather, the follower fingers 67 reach the outward bend in the guiding slot portions 47, as shown by C in FIG. 9. As a result, the jaws 60 move laterally away from one another as shown in FIG. 6, to their opened position. As the bars 60A of the jaws 60 separate, the weight of the waste will cause same to fall into a bottom of the bag, below the jaws 60.

The jaw-opening interface 45 therefore causes the opening of the jaws 60 only for the downward movement of the actuation link 40, i.e., when the lid 31 closes, according to the sequence of FIGS. 3-6. Accordingly, if waste is already present in the bottom of the bag, any odor emanating from the bag is concealed in the bag by the action of the jaws 60.

When the lid 31 reaches the closed position of FIG. 3, the detent 34 clamps onto the lid 31, holding same captive to the base 30.

It is pointed out that the guiding slot portions 47 may be positioned in the actuation link 40 in such a way that the clamping motion of the jaws 60 occurs when the lid 31 is almost closed, or even closed.

It is pointed out that the closing sequence of the lid (in sequence, FIGS. 5, 6, and 3) is performed rapidly (i.e., in seconds or fractions of seconds). Accordingly, the jaws 60 are separated from one another for a very brief moment during the two closing sequences. As a result, the jaws 60 are clamped most of the time, to limit the escape of waste odors from the device 10. It is observed that the lid 31 and jaws 60 are actuated concurrently by a single manual degree of actuation on the detent 34 during opening, and a single manual degree of actuation in applying pressure on the lid 31 during the closing of the lid 31.

It is observed from FIG. 3 that the contact point between the arms 33 and the upper edge 41 is generally vertically aligned with the pivot axis (pivot 32) of the lid 31. However, it may be desired to distance the contact point from vertical alignment with the pivot axis, such that a greater component of the force imparted by the biasing element 50 initially goes to raising the lid 31, by modifying the moment arm. This may allow for smaller biasing elements 50 to be used.

Moreover, the arms 33 are shown as being part of the lid assembly 13. It is alternatively considered to have the arms as part of the actuation link 40, or secured thereto, and therefore in contact with the lid 31.

The jaws 60 are shown as being oriented with the U-shape being upright. It is also possible to have the jaws 60 flipped over such that the U-shape is inverted. The configuration illustrated causes the gravity to help in moving the jaws 60 to the clamped position, as the jaws are in their lowermost position when in the clamped position.

The device 10 may be in a configuration without the ramp 48 of the one-way channel unit. This would result in the jaws 60 separating from one another during the opening of the lid 31.

1. A waste-disposal device comprising:
a structure having an opening at a top end and supporting a bag opened at the opening of the structure, with a closed end of the bag being below the opening;
a lid assembly mounted to the structure and having a lid pivoting to close/open access to the opening; and
a jaw mechanism comprising:
a single pair of jaws with at least one of the jaws movingly connected to the structure below the opening to move between a clamped position in which the jaws concurrently close off a portion of the bag passing therebetween, and an opened position in which the jaws are separated to allow waste to reach the closed end of the bag under the single pair of jaws;
an actuation link movingly connected to the structure and in a guide and follower engagement with the single pair of jaws to cause a movement of at least one of the jaws between the clamped position and the opened position as a result of movement of the actuation link relative to the structure, the actuation link contacting the lid for moving concurrently with the lid;
at least one biasing element biasing the actuation link upwardly to raise the lid; and
a retaining mechanism to hold the lid closed against a biasing pressure of the actuation link when the lid is pushed downwardly to close the access to the opening.

2. The waste-disposal device according to claim 1, wherein the jaws are U-shaped jaws with each said jaw being oriented upright in the clamped position.

3. The waste-disposal device according to claim 1, wherein the actuation link translates in a generally vertical direction relative to the structure, the actuation link having an edge slidingly contacting at least one arm of the lid to (1) displace the lid to open an access to the opening as biased by the at least one biasing element, and to (2) be pushed downward when the lid is manually pushed downwardly to close the access to the access to the opening.

4. The waste-disposal device according to claim 1, wherein both of the jaws are pivotally connected to the structure, and wherein the guide and follower engagement between the jaws and the actuation link comprises a follower finger projecting from each said jaw into guide slots in the actuation link for the jaws to move between the clamped position and the opened position as a function of a translation of the actuation link in the generally vertical direction.

5. The waste-disposal device according to claim 4, wherein the guide slots each have straight portion and a bent portion, the jaws moving from the clamped position to the opened position and back to the clamped position when each of the follower fingers moves sequentially from the straight portion, to the bent portion, to return to the straight portion.

6. The waste-disposal device according to claim 5, further comprising a one-way channel unit in the straight portion, with the bent portion joined in parallel relation with the straight portion, the jaws moving from the clamped position, to the opened position and back to the clamped position when the follower fingers each move into a corresponding one of the bent portion as a function of a closing of the lid, the jaws remaining in the clamped position when the follower fingers move in the straight portion and over the one-way channel unit when the lid is raised by the biasing force, the follower fingers being directed to the bent portion by the one-way channel unit.

7. The waste-disposal device according to claim 6, wherein the one-way channel unit is a ramp in the straight portion with the follower fingers passing over the ramp when the lid is being opened, the ramp directing the follower finger to the bent portion when the lid is being closed, to move the jaws to the opened position.

8. The waste-disposal device according to claim 7, wherein a translational joint is defined at respective pivots of the jaws with the structure for movement of the jaws along an axis of the pivots to allow the follower fingers to pass over the ramp, and further comprising biasing means to bias the jaws for the follower fingers to contact the ramp.

9. The waste-disposal device according to claim 4, comprising meshing on a periphery of the jaws, whereby the jaws are intermeshed for concurrent rotation between the clamped position and the opened position.

10. The waste-disposal device according to claim 1, further comprising at least one biasing element biasing the jaws toward one another.

11. The waste-disposal device according to claim 1, wherein the jaws have a wavy edge at a region of contact therebetween.

12. The waste-disposal device according to claim 1, wherein the structure is a container defining an inner cavity, with the jaw mechanism being at least partially within the inner cavity of the container.

13. The waste-disposal device according to claim 12, wherein the container comprises a top portion and a base portion, the top portion being pivotally connected to the base portion for access to the inner cavity of the container.

14. The waste-disposal device according to claim 1, wherein the lid assembly comprises an annular base secured to a structure, the annular base having a central opening providing access to the opening of the structure.

15. The waste-disposal device according to claim 14, wherein the retaining mechanism is a latch unit on the annular base cooperating with a catch on the lid.

16. A method for the disposal of a waste object in a waste-disposal device comprising a structure with an opening at a top end closed by a lid, a bag opened at the opening and having a closed end below the opening, jaws closing off a portion of the bag passing therebetween, the method comprising:
lifting the lid by a biasing force when the lid is released from a latched closed position;
receiving a waste object in the bag on top of the jaws;
separating the jaws for the waste object to fall under the jaws in the closed end of the bag as a result of a manual pressure applied on the lid to close the lid;
bringing the jaws against one another with the bag therebetween and the waste object captive in the closed end of the bag below the jaws a result of a manual pressure applied on the lid to close the lid; and
retaining the lid in the closed position against the biasing forces.

17. The method according to claim 16, wherein lifting the lid comprises keeping the jaws against one another continuously while the biasing force is applied to the lid.

18. The method according to claim 17, wherein keeping the jaws against one another comprises shifting the jaws laterally in engagement a one-way channel unit to avoid being opened.

19. The method according to claim 16, wherein separating the jaws and subsequently bringing the jaws against one another occur once the lid is in close proximity to a closed position.
